(19) United States
(12) Patent Application Publication
(10) Pub. No.: US 2008/0186010 A1
(43) Pub. Date: Aug. 7, 2008

(54) Locating Device

(76) Inventors: Uwe Skultety-Betz, Leinfelden-Echterdingen (DE); Bjoern Haase, Stuttgart (DE); Kai Renz, Leinfelden-Echterdingen (DE); Reiner Krapf, Reutlingen (DE)

Correspondence Address: MICHAEL J. STRIKER, 103 EAST NECK ROAD, HUNTINGTON, NY, 11743, US

(21) Appl. No.: 11/912,025

(22) PCT Filed: Jul. 4, 2006
(86) PCT No.: PCT/EP2006/063831

§ 371 Date: Oct. 19, 2007

(30) Foreign Application Priority Data
Jul. 27, 2005 (DE) 202005011783.8

(51) Int. Cl. G01V 3/00

(52) U.S. Cl. 324/67

(57) ABSTRACT

The invention relates to a locating device, in particular a handheld locating device (10), for detecting objects which are enclosed in a medium, said device having a housing (12) and at least one sensor apparatus, which is arranged in the housing (12), as well as an opening (24) which penetrates the device (10). The invention proposes that the opening (24) can be illuminated in a pulsating manner using at least one light source (34) which is arranged in the measuring device, the illumination repetition rate being dependent on the type of object detected.

The present invention relates to a locating device, in particular, a hand-held locating device for detecting objects embedded in a medium, according to the preamble of claim 1.

### RELATED ART

Locating devices for detecting objects embedded in a medium are often used in the craft sector and interior finishing, e.g., to locate electrical lines, water lines, or wooden beams. With the devices in the related art, a separate operating mode is usually provided for each object type, e.g., metal, wood, or a current-carrying line, so that only one object type depending on the preselected operating mode is ever located. Multisensors are also known, however, which are basically capable of locating different types of objects. In addition to the realization of the measurement function itself, the operation of the device is also crucial in terms of the quality of the measured result. A technologically advanced measurement device may not perform measurements well when used in the field if the user operates it incorrectly or makes false assumptions when operating it. When the user makes false assumptions regarding the exact sensor position, however, it is not possible to mark the location exactly, simply for this reason. In addition, if it is not certain what type of object was detected, serious mistakes may be made.

Publication DE 42 00 518 A1 makes known a hand-held metal detector that enables the user to qualitatively determine the position and depth of a metallic object embedded in a medium. With this measurement device, a sensor equipped with two coil pairs is used to locate metal, e.g., in a wall, and to ascertain the depth at which it is embedded. Each of the two coil pairs of the sensor is connected with an oscillator, and they oscillate continually at different frequencies. The signals, which are influenced by the metal, are measured and weighted for the evaluation. The intensity display in the form of a bar diagram depicts the position of the embedded metal. To mark the location of the embedded metal that was identified, the locating device described in DE 42 00 518 A1 includes a bore hole in the operative center of the sensor, through which, e.g., the drill bit of a drill or marking means may be guided. According to an embodiment of the locating device described, e.g., in DE 42 00 518 A1, it is provided to displaceably locate a stamp with a coloring means in this bore hole, in order to mark the site, e.g., on a wall.

Publication U.S. Pat. No. 6,259,241 B1 makes known a locating device for detecting objects embedded in a medium, which is designed to indicate the position of the object embedded behind the surface by emitting a directed light signal to the surface to be investigated. The device described in U.S. Pat. No. 6,259,241 B1 includes one or several light-emitting diodes, which are inserted in the housing and may emit a light signal via related openings in the housing wall when activated, the light signals being directed to the object to be investigated. When a sensor in the measurement device detects a related measurement signal, a single light signal or several linear light signals—depending on the design of the locating device—are cast on the object to be investigated, thereby indicating to the user the presence and approximate position of the embedded object.

Publication WO 87/06010 makes known a capacitive sensor and metal detector, with which a segment flashes when metal is detected, in order to notify the user to change the measurement mode.

Publication US 2001/0007420A1 makes known a device for detecting and locating hidden objects, which includes several LEDs of different colors that represent a detection mode that was selected by a user. With the locating device described in US 2001/0007420A1, for example, a yellow LED illuminates when the operating mode for detecting metallic objects was selected. In addition, an array of red LEDs indicates the signal strength that was detected. This device includes a number of sensors, which are capable of detecting different types of objects.

### ADVANTAGES OF THE INVENTION

The inventive locating device for detecting objects embedded in a medium includes an opening that passes through the device, which may be illuminated using at least one light source provided in the measurement device. A measurement device designed in this manner advantageously makes it possible to easily locate and mark an object embedded in a medium. Via the opening, which passes through the measurement device, and an illumination of this opening, the user of the inventive locating device is informed of the actual measurement range of the measurement device, and he is also informed—via the light signal—as to whether a measurement signal has been located in the region of the surface—defined by the opening—of the object to be investigated.

Using different types of illumination of the opening, the inventive locating device informs the user about the location of an embedded object and directly indicates the type of object that was detected.

This is advantageous with a locating device, in particular, with which various object types may be detected simultaneously without having to preselect a special operating mode for a particular object type. When searching for different types of objects, e.g., metal and current-carrying electrical lines or wood and current-carrying electrical lines, it is therefore possible to display an immediate differentiation between the various object types and communicate this to a user. When the object is detected, a user can therefore also see immediately what type of object it is. In particular, the opening in the housing of the device that defines the measurement site may be illuminated in a pulsing, i.e., flashing, manner, if a particular object type is detected.

Advantageous refinements of the inventive locating device according to claim 1 are possible due to the features listed in the dependent claims.

In an advantageous embodiment of the inventive locating device, the opening that passes through the measurement device is formed and/or delineated by a sleeve that has been inserted in the housing of the measurement device. The sleeve and, therefore, the opening that passes through the measurement device may be illuminated using at least one light source located in the measurement device, which radiates into the sleeve material. For this purpose, the sleeve is composed essentially of a transparent or semi-transparent plastic that makes it possible to further conduct the light signal that was inserted into the sleeve, in order to therefore illuminate the entire sleeve and, therefore, the entire opening that passes through the device. The sleeve is advantageously designed to scatter light diffusely, in order to distribute the light signal—which is inserted at least one point—evenly across the entire sleeve.

One or more light-emitting diodes are advantageously suited for use as the light source to illuminate the sleeve, which forms the opening that passes through the measurement device.

In a particularly advantageous embodiment of the inventive locating device, a plurality of light sources is provided to illuminate the opening that passes through the measurement device. It is advantageous in particular to design the sleeve—which delineates the opening—such that it may be illuminated with different colors. In this manner, it is possible to indicate to the user via an optically coded signal as to whether he must deal with an embedded object at the location—defined by the opening—behind the surface of the medium being investigated. It is possible, e.g., to indicate to the user using two colors, green and red, as to whether he may drill at the point defined by the opening (e.g., via a green-illuminated sleeve) or whether he should not drill, because an object was detected (represented, e.g., by a red-illuminated sleeve). If, according to the present invention, the red signal was illuminated constantly or in a pulsing manner, depending on the object type, it is possible to differentiate the detected object directly.

Via this different illumination of the opening passing through the measurement device, several pieces of information are communicated to the user easily and advantageously using a single depiction element. The opening that passes through the measurement device defines the region being investigated at that moment, and the different illumination—e.g., using different colors—depending on the measurement signal makes it possible to simultaneously transmit the additional information as to whether, e.g., the user may drill at the point being investigated at that moment, or whether he should not. In addition, objects may be differentiated using a different frequency of illumination, e.g., with the same color of illumination. A user receives all of this information in a manner that is intuitively very easily accessible, thereby making it unnecessary for him to look at a display that may be provided. This is an advantage in particular when using the locating device over one's head.

In a further embodiment of the inventive locating device, closing means may be provided that make it possible to close the opening that passes through the device depending on the measurement signal from at least one sensor. A mechanical flap may be provided in the measurement device, for instance, which closes the opening that passes through the measurement device as soon as a sensor in the measurement device detects a measurement signal that originates from an object embedded in the region being investigated using the locating device. In this manner, the user is prevented—via the optical display using the sleeve, which may be illuminated, and via the mechanical closure of the opening—from placing a mark or drilling when an embedded object is present.

The opening that passes through the measurement device is advantageously located concentrically with a coil located in the measurement device. In this manner it is ensured that the mark may be placed at the point of highest sensitivity of the sensor. The opening that passes through the measurement device is used for placement, e.g., of a pencil or a similar marking device in order to leave a mark on the surface of the medium being investigated and to bring it into exactly the correct position. A mark placed—through the opening—on the surface of the medium being investigated therefore defines the exact position of the object embedded in the medium. To this end, the marking opening in the measurement device must extend inside the coils of the inductive sensor of the measurement device. Advantageously, the opening that passes through the measurement device is located concentrically with the coils, so that the site of highest sensitivity of the sensor may be marked as exactly as possible.

Via the opening that passes through the measurement device and is provided in the inventive locating device, and which is illuminated depending on the measurement signal, the user may be advantageously made aware of the actual measurement region, the position and shape of the sensor, and the presence of a positive or negative signal in this measurement region.

Further advantages of the inventive locating device are disclosed in the drawing below and in the related description.

### DRAWING

An exemplary embodiment of an inventive locating device is depicted in the drawing, and it is described in greater detail in the subsequent description. The figures in the drawing, their descriptions, and the claims contain numerous features in combination. One skilled in the art will also consider these features individually and combine them to form further reasonable combinations, which are therefore also considered to be disclosed in this text.

FIG. 1 shows an embodiment of the inventive measurement device in a simplified, perspective overall view,

FIG. 2 shows a perspective cross section through the measurement device in FIG. 1, in the region of the opening that passes through the housing.

### DETAILED DESCRIPTION OF THE EXEMPLARY EMBODIMENT

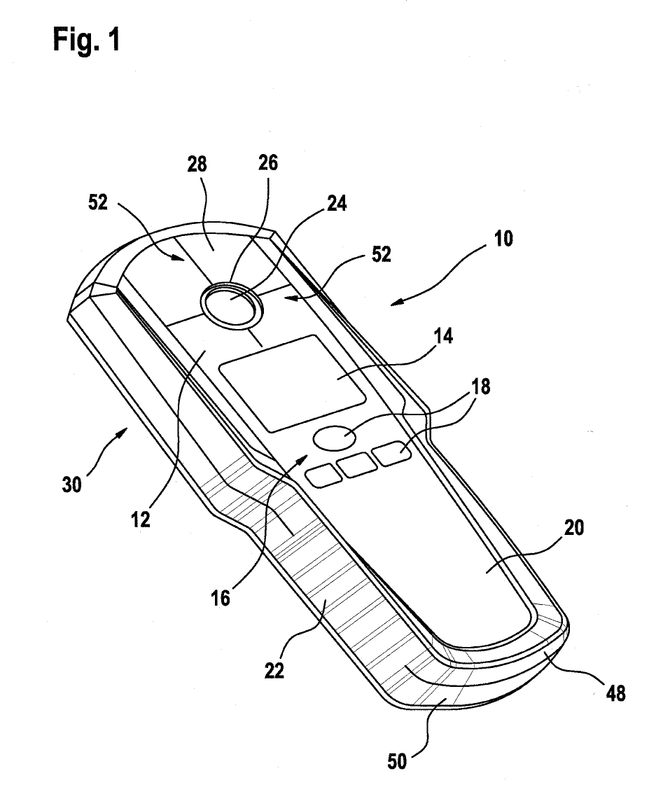

FIG. 1 shows an exemplary embodiment of inventive locating device 10 in a perspective overview. The locating device includes a housing 12, which is composed of a top half shell 48 and a lower half shell 50. Located inside the housing is at least one sensor, in particular an inductive sensor, with a coil assembly for metal detection, signal generation and evaluation electronics, and a power supply, e.g., in the form of batteries or rechargeable batteries. The device also includes a display 14 for outputting an output signal that is correlated with the measurement signal. Via display 14, e.g., a segmented bar display or a graphical display using an LCD, it is possible to depict the intensity of the detected measurement signal.

The inventive locating device also includes a control panel 16 with a row of control elements 18 that make it possible to turn the device on or off, and to start a measurement procedure.

In the region below control panel 16, the locating device according to FIG. 1 includes a region 20, which is designed—via its shape and material—as handle 22 for guiding the inventive locating device. Using this handle, the locating device is guided via its underside 30 over the surface of an object or medium to be investigated.

It may also be provided to provide and/or attach a marking means, e.g., a pencil in the region of handle 22, in or on housing 12 of the measurement device. A marker of this type may be clipped—e.g., in the region of handle 22—in related openings in housing 12, or it may be stored, e.g., inside the battery compartment of the measurement device. The user may therefore carry a pencil with him any time he uses the device without this interfering with his work, and without his having to look for it once he has located an object, or, e.g., to “carry it behind his ear”. Pencils appear to be particularly well-suited as marking means for practical use at the work site, although other types of marking means, e.g., a scriber, may also be used.

The measuring device has an opening 24 that passes through the housing on the side of locating device 10 opposite to handle 22. Opening 24 is formed by a sleeve 26 inserted in housing 12 and by the top side and bottom side of the housing of the measurement device.

During use, the inventive locating device is guided via its underside 30 over the surface of a medium to be investigated. In the manner described below, information—optical information, in particular—about the presence of an object embedded in the medium to be investigated is communicated to the user via display 14 and via sleeve 26, which may be illuminated.

In addition, the measurement site being investigated may be viewed directly by the user through opening 24 that passes through housing 12 of the locating device, so that metal objects such as nail heads or the like that may be located on the surface of the wall being investigated may be easily detected visually, thereby preventing measurement results that are undesired because they are based on a misinterpretation. The center of opening 24 is visualized via marking lines 52 formed on housing 12 of the measurement device. The opening need not necessarily have a round—circular, in particular—cross section. The opening may also have oval, rectangular, or square cross sections.

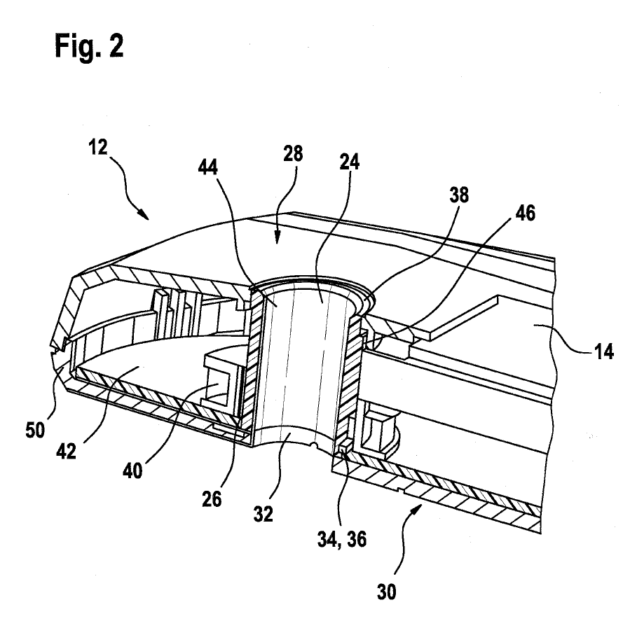

FIG. 2 shows a perspective cross section through the measurement device, in the region of opening 24 that passes through the housing.

A sensor coil 40 of an inductive metal detector is located in the front part—i.e., the part facing away from handle 22—of measurement device 10. The sensor coil and any associated electronic components required to control it are mounted on a printed circuit board 42. The center of the sensor is therefore located in the center of coil form 40. To enable the user of the device to mark the location of an embedded object using a marking device of his choice without removing the locating device from the surface being investigated, housing opening 24 is located in the center of sensor coil 40, through which a marking pen may be guided. In the region of the coil center, the outer wall of housing 12 is formed at least partially by inner wall 44 of sleeve 26. In the exemplary embodiment shown in FIG. 2, sleeve 26 has a round cross section, to ensure that it is matched to the shape of the coils enclosing it. As mentioned above, however, other cross-sectional shapes for the opening and the sleeve are also possible. Via a light source 34 (e.g., light-emitting diodes) mounted on printed circuit board 42, transparent sleeve 26 may be illuminated depending on the sensor data, or it may not be illuminated. The shape of the illuminated surface also simultaneously indicates the sensor position to the user.

As shown in FIG. 2, sleeve 24—which has been inserted in housing 12 of the measurement device and which, in the exemplary embodiment shown in FIG. 2, bears against housing wall 32 on inside 30 of lower half shell 50 of housing 12—defines opening 24 that passes through the measurement device. Sleeve 26 is made of a transparent plastic, e.g., a Plexiglas element, in which scattering centers are integrated. Due to these scattering centers, sleeve 26 has very good scattering capability and excellent light permeability.

A light signal may be inserted into sleeve 26 using a light source 34, which may be designed, e.g., as a light-emitting diode 36. Due to the high light permeability and high scattering capability of the material of sleeve 26, the light signal inserted into the sleeve as points is distributed evenly in the sleeve and, in particular, is also directed to upper edge 38 of sleeve 26, which is formed in the region of top 28 of the measurement device. In this manner, it is possible to illuminate the interior of the measurement device through the channel formed by opening 24 and, in particular, to clearly emphasize region 38—defined by the opening—on top 28 of the measurement device using a light signal.

In the exemplary embodiment shown in FIG. 2, the sleeve—which defines the opening that passes through the measurement device—is located concentrically with coil assembly 40 of an inductive sensor of the inventive locating device. Other cross sections for the sleeve shape are also possible, however. In addition to coil assembly 40 shown in FIG. 2, the inventive measurement device may also include further coil assemblies and further sensors for detecting objects embedded in a medium. It is also possible to provide only one or several capacitive sensors in the measurement device, and to design the sleeve to be in the direct vicinity of or inside a measuring capacitor. To this end, the sleeve could pass through one or more electrodes of a measuring capacitor.

In the exemplary embodiment shown, sleeve 26 is located inside coil assembly 40 to ensure that opening 24 in the measurement device is located in the region of highest sensitivity of the measurement device. In this manner it is ensured that a mark placed through opening 24 and onto the surface of a medium being investigated correlates as exactly as possible with the position of the embedded object that was located. The sleeve—which may be illuminated—therefore also serves to show the user the point on his measurement device at which the sensor is located, and at which point exactly the measurement is being carried out.

Sleeve 26—which may be illuminated—also serves to show the user that an embedded object has been located. If a metallic object is located—using the inductive sensor—in the medium being investigated, one or more light sources 34 may be controlled based on the measurement signal that was detected, in order to illuminate sleeve 26. It is possible, for example, to allow the sleeve to be illuminated continually in red when a metallic object has been detected. A user is therefore notified that a metallic object has been detected, and that he should therefore not drill at this point.

The inventive locating device also makes it possible to differentiate between different types of objects. When the device detects, e.g., using an AC sensor provided in the device, a current-carrying electrical line, the sleeve is illuminated in a pulsing manner, i.e., with a fixed rate of repetition, so that the red light now flashes with a special frequency. The user is notified—via the pulsing red light—not only that an object has been detected, but what type of object has been detected. It is a current-carrying electrical line in the exemplary embodiment. The rate of repetition of the illumination is therefore an indicator of the type of object that has been detected. In this exemplary embodiment in particular, the constant illumination of the sleeve—which occurs when a metallic but non-current-carrying object has been detected—represents the borderline case of an infinitely high rate of repetition.

In other exemplary embodiments of the inventive locating device, a differentiation by further object types may also be visualized, in principle, via different frequencies of illumination of the sleeve, by illuminating the sleeve, e.g., in red, or via a pulsing at a rapid or slow rate depending on the type of object that was detected.

In addition to the simple object display, which merely notifies a user that an object has been located, it is therefore also possible to differentiate the objects by type using the different type of illumination of the sleeve (constant, pulsing, or pulsing rapidly or slowly). This is advantageous, in particular, when various various object types may be detected simultaneously using the inventive locating device without having to select a special operating mode for a particular object type.

To optimize the detectability of the optical signal transmitted via sleeve 26, it is desirable for transparent sleeve 26 to radiate as homogeneously as possible in the center of the detector when it illuminates. Since the user typically views sleeve 26 at a relatively acute angle, a good, even illumination of the sleeve is important, particularly in its top portion.

For reasons of cost, only a small number of punctiform light sources 34 are installed on printed circuit board 42 in practical applications. Flat light emitters, which would allow the sleeve to be illuminated evenly, are technically more difficult to realize and are more cost-intensive, but they represent another possible realization of light source 24. The problem of even illumination may be solved by making transparent sleeve 24 out of a plastic material that contains optical scattering centers. The sleeve is advantageously made of “milk glass” to a certain extent.

A more homogeneous illumination of sleeve 26 may also be realized by providing visible inner surface 44 of transparent housing sleeve 26 with a suitable, raw, and therefore light-scattering surface structure. When the sleeve is designed as a plastic injection-moulded part, this may take place by eroding the associated tool surfaces in a suitable manner. Regarding surfaces 46—facing the interior of the housing—of sleeve 26 it is more advantageous, however, to design them to be smooth. This may also apply for the lower part of the outer surface of the housing sleeve, which is difficult for the user to see. The light emitted by illumination sources 34 is reflected to a large extent on smooth surfaces, and it is guided in the direction of visible upper outside 38 of sleeve 26, as in an optical waveguide. This function may be further improved when these smooth housing surfaces are made reflective using a suitable coating.

In further embodiments of the inventive measurement device, several light sources may be provided, which also make it possible to insert light of different colors into sleeve 26, in order to thereby provide the user with information—via a color-coded signal—about the presence of an object that has been located. Using a green-illuminated sleeve, for instance, the user may be notified that he may safely drill in the surface under investigation in the region defined by opening 24 up to a drilling depth indicated in the display.

It is also possible, via the different illumination of inserted sleeve 26, to indicate to the user whether an embedded object was detected (the sleeve is illuminated in red, for example), or whether a measurement signal is not present, and drilling can therefore be carried out safely (the sleeve may be illuminated in green in this case, for instance).

It would also be possible, as an alternative, to correlate the intensity of the light inserted into sleeve 26 with the detection signal, in order to provide the user with the additional information about a signal trace, i.e., the direction of an increasing measurement signal.

In a particularly advantageous embodiment, transparent sleeve 26 of the measurement device performs a mechanical task in addition to the display function. It is possible, e.g., to fix the position of printed circuit board 42 inside the lower part of the housing sleeve 26. This is attractive for metal detectors in particular, since fixation using a metal screw may therefore be eliminated in the region of sensor coil 40. A screw of this type may potentially influence the measurement performance of the metal sensor.

The inventive locating device is not limited to the exemplary embodiment depicted in the figures.

In an embodiment of the inventive locating device, for example, a closing mechanism may be provided that makes it possible to automatically close opening 24 that passes through the device, depending on the measurement signal from a sensor. In this embodiment, the user could be notified about, e.g., a detected object embedded behind the surface being investigated using an illumination signal of sleeve 26, while opening 24 is simultaneously closed, e.g., using a mechanical flap mechanism, e.g., in order to entirely prevent drilling in the region of the object that was located.

With the inventive locating device, various object types—i.e., metallic objects, magnetic objects, current-carrying objects and wooden objects—may be advantageously detected and differentiated simultaneously. A separate operating mode for every individual object type is not required. Using the different type of illumination of an output unit in the form of a sleeve—which may be illuminated—that passes through the device housing, it may therefore be indicated whether an object has been located or not, and an object may be differentiated immediately according to different object types.

In principle, the output of the measurement result may be coded optically or acoustically. For example, a constant tone, or a constant pitch, could delineate a first object type from a second object type, which may be characterized, e.g., using a pulsing tone or a pulsing pitch. A locating device of this type would then include an output unit that emits an output signal, with the rate of repetition of the output signal depending on the type of object that was detected.

The inventive locating device is not limited to the use of inductive sensors nor, in particular, to the use of only one coil assembly. Advantageously, it may be provided that further, e.g., capacitive sensors are located in the housing of the locating device, so that a large number of different object types may be detected. To locate an object embedded in a medium as exactly as possible using the inventive locating device, opening 24 that passes through the locating device should be located in the operative center of the sensors.

The inventive measurement device may also be designed, in principle, as a capacitive measurement device, possibly with additional diagnostics.

What is claimed is:

1. A locating device, in particular, a hand-held locating device (10) for detecting objects embedded in a medium, with a housing (12), at least one sensor device, which is located in the housing (12), and an opening (24), which extends through the housing (12),
wherein
the opening (24) may be illuminated using at least one light source (34) located in the measurement device, the rate of repetition of the illumination depending on the type of object that is detected.

2. The locating device as recited in claim 1,
wherein
a color-coded light signal is provided to illuminate the opening (24) of the measurement device (10).

3. The locating device as recited in claim 1,
wherein
the opening (24) may be illuminated with at least two different colors.

4. The locating device as recited in claim 1,
wherein
a plurality of light sources (34, 36) is provided to illuminate the opening (24) of the measurement device (10).

5. The locating device as recited in claim 1,
wherein
at least one light source (34) is a light-emitting diode (LED) (36).

6. The locating device as recited in claim 1,
wherein
the opening (24) is delineated by a sleeve (26), it being possible to illuminate the sleeve (26) using at least one light source (34, 36) located in the measurement device.

7. The locating device as recited in claim 6,
wherein
the sleeve is designed to scatter light diffusely.

8. The locating device as recited in claim 6,
wherein
the sleeve (26) is composed essentially of an at least partially transparent plastic.

9. The locating device as recited in claim 1,
wherein
closing means are provided that make it possible to close the opening (24) that passes through the device (10) depending on a measurement signal from at least one sensor.

10. The locating device as recited in claim 1,
wherein
the sensor device includes at least one inductive sensor, which is used to locate objects.

11. The locating device as recited in claim 1,
wherein
the sensor device includes at least one capacitive sensor.

12. The locating device as recited in claim 1,
wherein
the sensor device includes at least two sensors for locating different types of objects.
